(19) United States
(12) Patent Application Publication
(10) Pub. No.: US 2026/0228991 A1
(43) Pub. Date: Aug. 6, 2026

(54) GHOST IMAGE MITIGATION

(71) Applicant: Meta Platforms Technologies, LLC, Menlo Park, CA (US)

(72) Inventor: Dmitry Sizov, San Jose, CA (US)

(21) Appl. No.: 19/530,151

(22) Filed: Feb. 4, 2026

Related U.S. Application Data
(60) Provisional application No. 63/754,534, filed on Feb. 5, 2025.

(51) Int. Cl. G06T 19/00; G02B 5/18; G02B 6/10; G02B 27/01

(52) U.S. Cl. CPC G06T 19/006; G02B 5/18; G02B 6/10; G02B 27/0172

(57) ABSTRACT

An augmented reality (AR) display system includes a waveguide having a surface and a display field of view (FOV), first and second input optical elements disposed over the surface of the waveguide, first and second projectors respectively configured to emit first and second display light to the first and second input optical elements and couple the first and second display light into the waveguide, where the first projector is oriented at a first tilt angle relative to the waveguide surface, the second projector is oriented at a second tilt angle relative to the waveguide surface, the first tilt angle is at least one-half of a field of view of the first projector, and the second tilt angle is at least one-half of a field of view of the second projector.

### CROSS-REFERENCE TO RELATED APPLICATION

This application claims the benefit of priority under 35 U.S.C. § 119(e) of U.S. Provisional Application No. 63/754,534, filed Feb. 5, 2025, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 shows schematic views of a comparative augmented reality display according to some embodiments.

FIG. 2 shows schematic views of an illustrative augmented reality display according to some embodiments.

FIG. 3 is an illustration of an example artificial-reality (AR) system according to some embodiments of this disclosure.

FIG. 4 is an illustration of an example artificial reality (AR) system with a handheld device according to some embodiments of this disclosure.

FIG. 5A is an illustration of example user interactions within an artificial reality system according to some embodiments of this disclosure.

FIG. 5B is an illustration of example user interactions within an artificial reality system according to some embodiments of this disclosure.

FIG. 6A is an illustration of example user interactions within an artificial reality system according to some embodiments of this disclosure.

FIG. 6B is an illustration of example user interactions within an artificial reality system according to some embodiments of this disclosure.

FIG. 7 is an illustration of an example wrist-wearable device of an artificial reality system according to some embodiments of this disclosure.

FIG. 8 is an illustration of an example wearable artificial reality system according to some embodiments of this disclosure.

FIG. 9 is an illustration of an example augmented reality system according to some embodiments of this disclosure.

FIG. 10A is an illustration of an example virtual reality system according to some embodiments of this disclosure.

FIG. 10B is an illustration of another perspective of the virtual reality systems shown in FIG. 10A.

FIG. 11 is a block diagram showing system components of example artificial-and virtual reality systems.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Virtual reality (VR) and augmented reality (AR) eyewear devices or headsets may enable users to experience events, such as interactions with people in a computer-generated simulation of a three-dimensional world or viewing data superimposed on a real-world view. By way of example, superimposing information onto a field of view may be achieved through an optical head-mounted display (OHMD) or by using embedded wireless glasses with a transparent heads-up display (HUD) or augmented reality (AR) overlay. VR/AR eyewear devices and headsets may be used for a variety of purposes. For example, governments may use such devices for military training, medical professionals may use such devices to simulate surgery, and engineers may use such devices as design visualization aids.

Virtual reality and augmented reality devices and headsets typically include an optical system having a microdisplay and imaging optics. The microdisplay is configured to provide an image to be viewed either directly or indirectly using, for example, a micro OLED display or by illuminating a liquid-crystal based display such as a liquid crystal on silicon (LCOS) microdisplay.

Display light may be projected to the eyes of a user using a waveguide display system where the light is in-coupled into the waveguide, transported therethrough by total internal reflection (TIR), and out-coupled when reaching the position of a viewer's eye. The imaging optics may include input-coupling and output-coupling elements such as surface relief gratings/mirrors that are configured to couple light into and out of the waveguide. A vertical grating/mirror coupler, for instance, may be configured to change an out-of-plane wave-vector direction of light to a diagonal direction inside the waveguide substrate and accordingly direct the passage of light through the waveguide.

The waveguide optics may be advantageously configured to create illuminance uniformity and a wide field of view (FOV). The FOV relates to the angular range of an image observable by a user, whereas illuminance uniformity may include both the uniformity of image light over an expanded exit pupil (exit pupil uniformity) and the uniformity of image light over the FOV (angular uniformity). As will be appreciated, an input-coupling grating may determine the angular uniformity and coupling efficiency of image light. Moreover, the field of view of an augmented reality waveguide may be strongly dependent on the refractive index of the waveguide medium itself and its geometry.

As will be appreciated, in comparative AR headsets, image light produced by an LED panel is typically collimated and directed to an input coupler of a waveguide. A portion of the incident light may not be diffracted into the waveguide, however, and may be instead reflected due to specular reflection or zero-order diffraction at the input coupler. In configurations where the panel is parallel to the waveguide, the reflected light is re-focused onto the panel's microlens array and subsequently onto an LED pre-reflector, which redirects the light back toward the input coupler. This feedback may produce a secondary ghost image that can degrade visual quality and result in an unacceptable user experience.

Notwithstanding recent developments, it would be advantageous to provide a head-mounted display, such as a wearable augmented reality display, having a compact form factor, wide field of view, high resolution, high brightness, and low power consumption.

In some embodiments, a display system includes two or more panels or projectors per color as an alternative to a single per color light source. Although each projector may provide a comparatively reduced field of view, images from two or more projectors may be combined (i.e., stitched) to produce a single, wide field of view.

Each projector is tilted relative to the waveguide plane by at least one half of the field-of-view angle of that projector such that reflected light misses the originating panel, thereby mitigating ghost image formation. Because each projector is tilted, the image from each projector appears toward a lateral portion of the observer's field of view; however, the combined image is centered within the observer's field of view.

An augmented reality display system may include a waveguide having a surface and a display field of view (FOV) defined by an angular range of display light out-coupled from the waveguide toward a user. First and second input optical elements, such as first and second in-coupling elements, may be disposed over the surface of the waveguide. The display system may further include a first projector configured to emit first display light to the first input optical element, where the first input optical element is configured to couple the first display light into the waveguide, and a second projector configured to emit second display light to the second input optical element, where the second input optical element is configured to couple the second display light into the waveguide. In some embodiments, the first projector may be oriented at a first tilt angle relative to the waveguide surface and the second projector may be oriented at a second tilt angle relative to the waveguide surface, where the first tilt angle and the second tilt angle are each at least one half of the display field of view.

In some embodiments, a display system includes a waveguide configured to transport and deliver image light to a user's eye with a compact form factor suitable for augmented-reality eyewear. The waveguide may include a transparent substrate having one or more optical surfaces that guide light by total internal reflection. The transparent substrate can be formed as a planar plate, a curved plate, or a laminated stack of plates, and may be configured to present artificial-reality content within a portion or substantially all of the user's display field of view.

The waveguide may include a single guiding layer or multiple guiding layers. In a single-layer architecture, image light is coupled into a monolithic substrate and distributed across the substrate by total internal reflection until it reaches an output region where the light is directed toward the user. In a multi-layer architecture, the waveguide may include a stack of optically bonded plates or films that provide color-separated guiding paths (for example, layers dedicated to red, green, and blue spectral bands) or function-separated paths (for example, a layer optimized for in-coupling, a layer optimized for pupil expansion, and a layer optimized for out-coupling). Layers may be joined using optically clear adhesives selected to match or complement the refractive indices of adjacent materials to minimize Fresnel reflections and maintain guiding efficiency.

The transparent substrate of the waveguide may include glass, polymeric materials, or hybrid composites. Suitable glasses include aluminosilicate, borosilicate, soda-lime, and high-index optical glasses. Suitable polymers include polycarbonate, cyclic olefin polymer (COP), cyclic olefin copolymer (COC), polymethyl methacrylate (PMMA), and polyurethane-based optical films. In some embodiments, high-index materials are used to increase the critical angle for total internal reflection and thus support larger acceptance angles for in-coupled light, which can improve the achievable display field of view. The waveguide may further include index-modifying coatings or layers, such as sol-gel films or inorganic thin films, to tune surface or bulk refractive index for improved coupling efficiency.

A surface of the waveguide may include one or more regions engineered to support in-coupling, guiding, and out-coupling operations. In some embodiments, the surface of the waveguide includes input optical elements disposed over selected areas to couple display light into the guiding medium. Input optical elements may include surface-relief diffraction gratings patterned directly into the surface of the waveguide, thin-film gratings deposited onto the surface, or replicated microstructures formed on the surface via embossing or nano-imprint lithography. The surface may further include anti-reflection coatings tailored to the incidence angles of display light to reduce zero-order transmission and specular reflection that could otherwise contribute to ghost artifacts. In some embodiments, the surface topography and coating stack are designed to control polarization, phase, and amplitude of incident display light so that out-of-plane light is redirected to tilted or in-plane guided modes with high efficiency.

A surface of the waveguide may also include an output optical element configured to out-couple guided light toward the user. The output optical element can be implemented as a grating or microstructure formed over the surface and can provide exit-pupil expansion in at least one lateral dimension to increase the eyebox and allow for positional tolerance of the eyewear relative to the user's eye. In some embodiments, the surface pattern is chirped or multiplexed across an output region to equalize extraction efficiency over a range of incidence angles. The distribution of coupling strength across the surface may be apodized to improve brightness and uniformity across the display field of view.

The surface finish and protective coatings of the waveguide may be selected to maintain optical performance over time. Exterior surfaces may include hardcoat layers for scratch resistance, hydrophobic or oleophobic layers to reduce contamination, and anti-reflection coatings to suppress stray reflections from ambient light. In some embodiments, polarization-managing films, such as wire-grid polarizers or quarter-wave plates, are laminated to the surface of the waveguide to optimize coupling efficiencies for polarized display light and to manage polarization states within the guiding medium. The surface may also include fiducials or alignment features to facilitate registration of input optical elements with corresponding projector modules during assembly.

One or more input optical elements may be disposed over the surface of the waveguide to couple display light into the guiding medium. Input optical elements can include surface relief diffraction gratings, volume holographic gratings, reflective microstructures, or thin-film mirrors with engineered phase or amplitude response. In some embodiments, vertically oriented grating couplers change the wave-vector direction of out-of-plane display light to a tilted or in-plane direction suitable for guiding. Grating parameters such as period, duty cycle, depth, blaze angle, and refractive-index contrast may be selected to maximize coupling efficiency over a target spectral band and incidence range.

Operation of the waveguide may include in-coupling of display light at one or more input regions on the surface, propagation of the coupled light by total internal reflection within the substrate, and out-coupling of the guided light at an output region formed over the surface toward the user's eye. The waveguide geometry and refractive indices establish a display field of view that may be defined by an angular range of out-coupled light observable by the user. Angular uniformity can be engineered by selecting input-coupler parameters that shape the distribution of guided modes and by designing out-coupler parameters that equalize extraction efficiency across incident angles. Spatial uniformity across an expanded exit pupil may be achieved by varying grating duty cycle or depth across the surface of the output region or by employing multi-order out-coupling with controlled phase relationships.

Thermal and mechanical stability may be enhanced through material selection and by integrating stress-relief features or compliant bonding layers that maintain alignment and optical performance under temperature cycling and daily wear. The waveguide architecture can be adapted to various eyewear geometries. For example, a planar waveguide may be integrated behind or within a lens element of an eyeglass frame, while a curved waveguide may conform to a lens curvature to reduce overall thickness and bezels. Coupling regions on the surface may be placed at peripheral portions of the waveguide to preserve a central clear aperture for ambient see-through. Electrical and mechanical interfaces for projector modules may be positioned to align input coupling regions on the surface with corresponding projectors, while maintaining a compact form factor and balanced weight distribution suitable for wearable devices.

In some embodiments, first and second projectors are provided to deliver display light to corresponding input optical elements on the surface of the waveguide. Each projector may be positioned at a peripheral portion of an eyewear housing and oriented to direct collimated display light toward an associated in-coupling region. The projectors may be arranged to produce complementary image regions that are subsequently stitched to form a combined image within the display field of view.

Each projector may include a microdisplay panel and collimation optics defining an entrance pupil. The microdisplay panel may be implemented using reflective spatial light modulator technology, such as liquid crystal on silicon, ferroelectric liquid crystal on silicon, or digital micromirror device, and may be configured to modulate incident illumination to form image light. The collimation optics may include one or more lenses, prisms, or lenslet arrays configured to transform modulated illumination into a collimated or quasi-collimated beam with a specified pupil geometry. In some embodiments, the entrance pupil exhibits a non-rotationally symmetric aperture to efficiently utilize portions of the waveguide surface allocated for input coupling and to tailor angular content for improved uniformity within the guiding medium.

The first projector may be configured to emit first display light toward a first input optical element and the second projector may be configured to emit second display light toward a second input optical element. The first input optical element and the second input optical element may be positioned on distinct regions of the waveguide surface, such as opposite lateral portions or diagonally offset portions, to distribute coupling across the waveguide and reduce localized brightness peaks. The optical axes of the first and second projectors may be directed to respective in-coupling regions such that projected beams enter the waveguide with incidence angles selected to populate guided modes over a target angular range corresponding to the display field of view.

In some embodiments, the first and second projectors are oriented at respective tilt angles relative to the waveguide surface that are each at least one-half of the projector field of view. The tilt angles may be measured between the optical axis of the projector and a normal to the waveguide surface or a defined reference plane of the waveguide. By selecting tilt angles that meet or exceed one-half of the projector field of view, light reflected at the corresponding input optical elements is not incident on the microdisplay panels of the projectors, thereby mitigating feedback pathways that can produce secondary ghost images. The tilt angles may be substantially equal and symmetric about a plane normal to the waveguide surface so that individual images appear toward lateral portions of the observer's field of view while the stitched image is centered. In other embodiments, the tilt angles differ by at least five degrees to accommodate asymmetric layouts or to balance color-channel brightness and uniformity.

In some embodiments, the projectors may be disposed in an asymmetric layout relative to the waveguide to increase utilization of input-coupling regions and to accommodate mechanical constraints of an eyewear housing. For example, the first projector may be placed proximate to an upper temporal portion of a frame and the second projector proximate to a lower nasal portion, with optical fold elements used to route beams to designated in-coupling regions while maintaining compact packaging. Electrical and thermal interfaces may be integrated into the projector modules to support high-brightness illumination sources, such as lasers, VECSELs, or SLEDs, with heat-spreading features and drive electronics arranged to minimize weight and maintain user comfort.

In some embodiments, each projector includes a microlens array positioned proximate to the microdisplay panel to homogenize illumination and reduce speckle, and may further include a reflector disposed behind the panel to increase emission efficiency and improve optical fill factor. Illumination modules associated with the projectors can include beam expanders, such as Fresnel structures or volume-grating implementations, to enlarge the illumination profile in one or two dimensions prior to modulation by the microdisplay. Polarization-managing elements, such as linear polarizers or quarter-wave plates, may be incorporated within the projector optics to align illumination polarization with the in-coupling efficiency of the input optical elements. The projectors may be calibrated during assembly to align image regions and to establish stitching parameters for forming a combined image that is substantially centered within the user's field of view, and a controller may periodically recalibrate alignment and stitching parameters to compensate for mechanical drift or aging effects over time.

The panels may have any suitable areal geometry, and the collimation optics, including the entrance pupil, need not exhibit rotational symmetry. The projectors may be arranged in non-orthogonal or non-square orientations to better utilize the portion of the waveguide allocated for input coupling. Volume color-combining optics, such as an X-cube or other combining prism, may be configured to combine more than three panels and to accept collimated light from each panel that is tilted with respect to the entrance pupil. Image stitching may be performed in software and repeated over time to compensate for alignment drift due to system aging.

According to further embodiments, a display system includes a waveguide having a surface and a display field of view defined by an angular range of display light out-coupled from the waveguide toward a user, a plurality of input optical elements disposed over the surface of the waveguide, for each of a plurality of colors, at least two projectors respectively configured to emit display light to corresponding input optical elements, where the corresponding input optical elements are configured to couple the display light into the waveguide, where each projector includes a microdisplay panel and collimation optics defining an entrance pupil, and each projector is oriented at a respective tilt angle relative to the waveguide surface that is at least one-half of the display field of view such that light reflected at the corresponding input optical element is not incident on the microdisplay panel, and a controller configured to stitch images from the at least two projectors for each color to produce a combined image having a field of view that is substantially centered within the user's field of view.

The disclosed configurations may also be used in combination with conventional configurations in which one or more panels are parallel to the waveguide or only slightly tilted, with ghost image mitigation for such panels provided by complementary techniques while other panels for the same or different colors are tilted as described.

The disclosed configurations mitigate ghost images without sacrificing projector emission efficiency, which is advantageous for the constrained power budgets of augmented reality eyewear. Further, the use of smaller panels affords greater flexibility in optical design and presents opportunities for additional efficiency improvements.

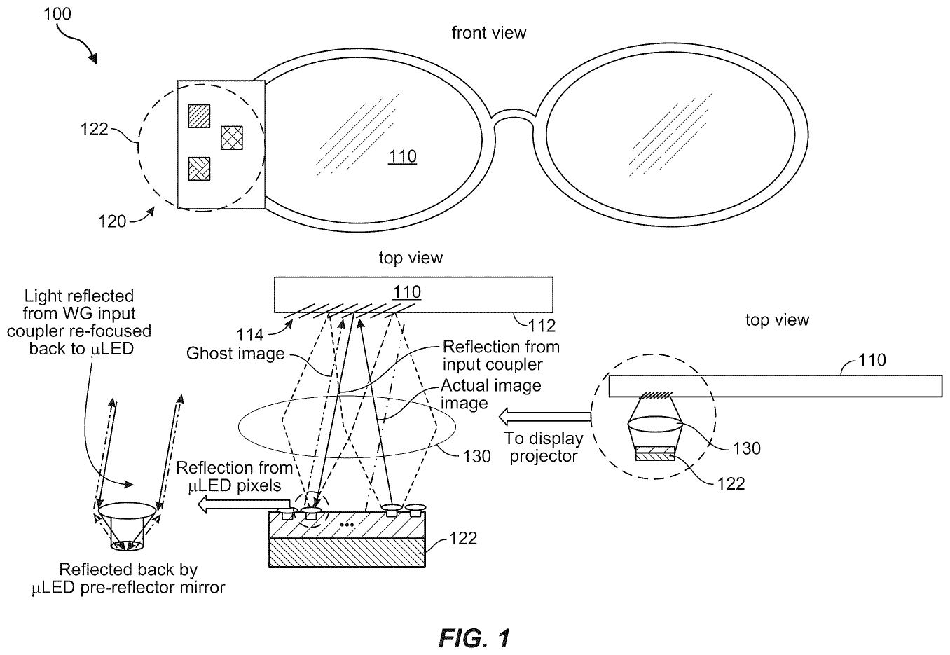

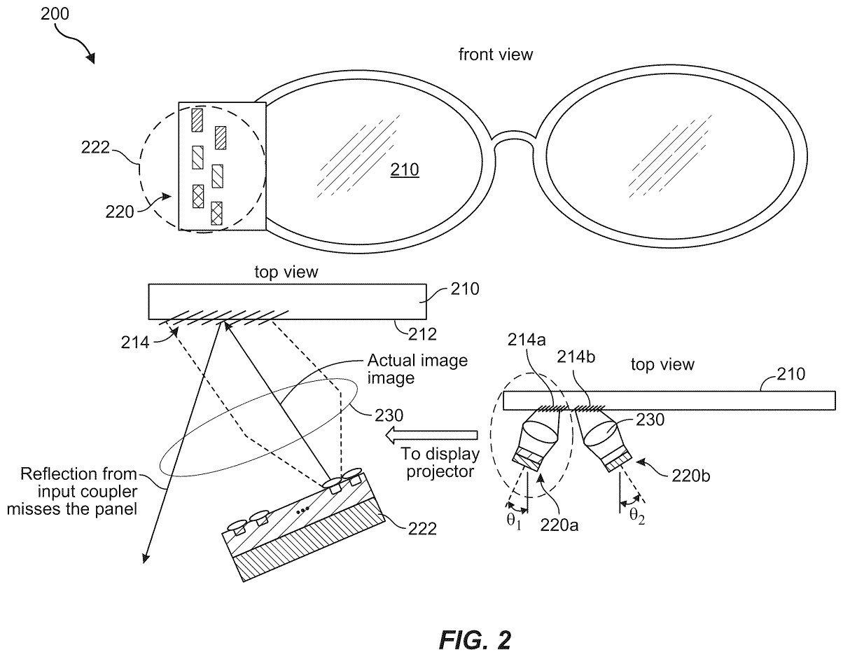

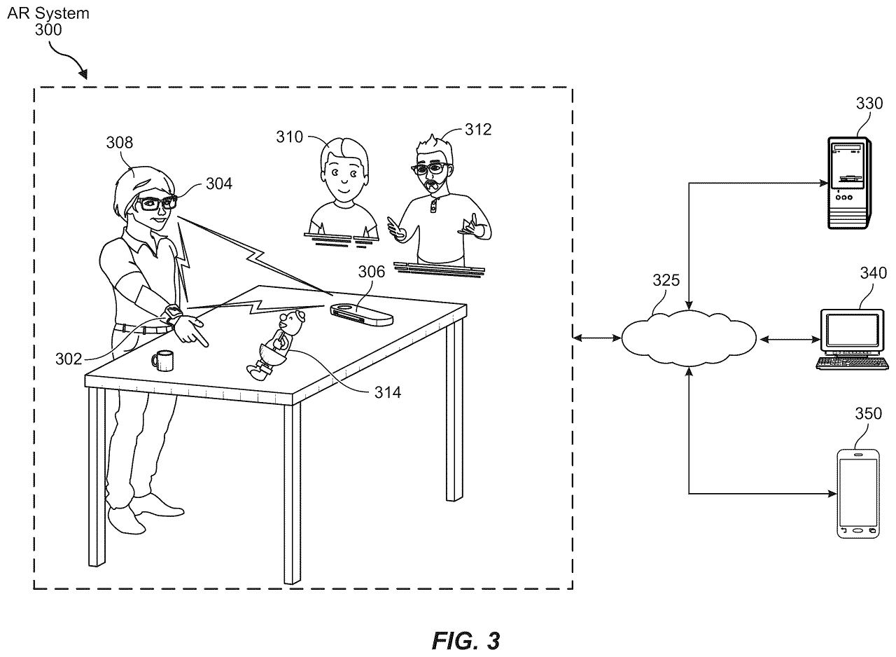

The following will provide, with reference to FIGS. 1-11, detailed descriptions of methods and related structures associated with display systems exhibiting decrease ghost image formation. The discussion associated with FIGS. 1 and 2 includes a description of example display system architectures. The discussion associated with FIGS. 3-11 relates to exemplary virtual reality and augmented reality devices that may include a display system as disclosed herein.

FIG. 1 illustrates a comparative augmented-reality display 100 in which reflected light at an input region can produce a secondary ghost image. Display 100 includes a waveguide 110 having a surface 112 engineered for in-coupling, guiding by total internal reflection, and out-coupling toward a user. An input optical element 114 is disposed over a portion of surface 112 and is configured to couple display light into waveguide 110.

Projectors 120 are positioned to emit image illumination toward input optical element 114. Each projector 120 includes a display panel 122 that modulates incident illumination to form image light and collimating optics 130 that transform the modulated illumination into a collimated or quasi-collimated beam directed to input optical element 114. In the comparative arrangement shown, a portion of the incident illumination is not diffracted into waveguide 110 and is instead reflected at input optical element 114. When the optical axis of projector 120 is parallel or only slightly tilted relative to surface 112, the reflected light can be re-focused onto display panel 122 by collimating optics 130, producing feedback that generates a secondary ghost image observable within the user's field of view.

FIG. 2 illustrates an augmented-reality display 200 that mitigates ghost reflections using tilted projectors. Display 200 includes a waveguide 210 having a surface 212 engineered for in-coupling, guiding by total internal reflection, and out-coupling toward a user. First and second input optical elements 214a and 214b are disposed over selected portions of surface 212 and are configured to couple respective display light into waveguide 210.

First and second projectors 220a and 220b are positioned to emit image illumination toward input optical elements 214a and 214b, respectively. Each projector 220 includes a display panel 222 that modulates incident illumination to form image light and collimating optics 230 that transform the modulated illumination into a collimated or quasi-collimated beam directed to the associated input optical element. Projector 220a is oriented at a first tilt angle θ1 relative to surface 212, and projector 220b is oriented at a second tilt angle θ2 relative to surface 212. The tilt angles θ1 and θ2 are selected to be at least one-half of the display field of view so that light reflected at input optical elements 214-1 and 214-2 is not incident on the corresponding display panels 222. By preventing reflected light from re-entering the projector optics, the configuration of display 200 reduces feedback pathways that otherwise generate secondary ghost images, while images produced by projectors 220-1 and 220-2 are stitched to form a wide, centered field of view.

This disclosure relates to augmented reality display systems that mitigate ghost images caused by light reflected at the waveguide input coupler. Instead of a single projector per color, two or more tilted projectors per color are used. The projectors are tilted by at least one-half of the field-of-view angle so that any reflected light misses the originating panel, preventing feedback that generates ghost images.

The individual images may be stitched to form a wide, centered field of view. Panels can have various geometries and collimation optics need not be rotationally symmetric. Non-orthogonal projector layouts and volume color-combining prisms may be incorporated into some embodiments. Software-based stitching may be temporally updated to correct system drift. The disclosed system configurations reduce ghosting without sacrificing emission efficiency and enable smaller panels for greater optical design flexibility and potential efficiency gains.

### Example Embodiments

Example 1: A display system includes a waveguide having a surface and a display field of view (FOV) defined by an angular range of display light out-coupled from the waveguide toward a user, first and second input optical elements disposed over the surface of the waveguide, a first projector configured to emit first display light to the first input optical element, wherein the first input optical element is configured to couple the first display light into the waveguide, and a second projector configured to emit second display light to the second input optical element, wherein the second input optical element is configured to couple the second display light into the waveguide, where the first projector is oriented at a first tilt angle relative to the waveguide surface, the second projector is oriented at a second tilt angle relative to the waveguide surface, the first tilt angle is at least one-half of a field of view of the first projector, and the second tilt angle is at least one-half of a field of view of the second projector.

Example 2: The display system of Example 1, where the waveguide includes a transparent substrate and further includes an output optical element configured to out-couple guided light toward a user with exit pupil expansion in a lateral dimension corresponding to a combined field of view produced by the first display light and the second display light.

Example 3: The display system of any of Examples 1 and 2, where the first tilt angle and the second tilt angle are unequal.

Example 4: The display system of any of Examples 1-3, where the first and second input optical elements each include a surface-relief diffraction grating.

Example 5: The display system of any of Examples 1-4, where the first and second input optical elements include vertically oriented grating couplers configured to convert out-of-plane display light to tilted guided light within the waveguide.

Example 6: The display system of any of Examples 1-5, where the first and second projectors each include a microdisplay panel and collimation optics defining an entrance pupil having a non-rotationally symmetric aperture.

Example 7: The display system of any of Examples 1-6, where the first projector and the second projector are arranged in an asymmetric layout.

Example 8: The display system of any of Examples 1-7, where the first tilt angle and the second tilt angle are opposite in sign.

Example 9: The display system of any of Examples 1-7, where the first tilt angle differs from the second tilt angle by at least five degrees.

Example 10: The display system of any of Examples 1-9, where the first and second tilt angles are symmetric about a plane normal to the waveguide surface.

Example 11: A display system includes a waveguide having a surface and a display field of view defined by an angular range of display light out-coupled from the waveguide toward a user, a plurality of input optical elements disposed over the surface of the waveguide, for each of a plurality of colors, at least two projectors respectively configured to emit display light to corresponding input optical elements, where the corresponding input optical elements are configured to couple the display light into the waveguide, where each projector includes a microdisplay panel and collimation optics defining an entrance pupil, and each projector is oriented at a respective tilt angle relative to the waveguide surface such that light reflected at the corresponding input optical element is not incident on the microdisplay panel; and a controller configured to stitch images from the at least two projectors for each color to produce a combined image having a field of view that is substantially centered within the user's field of view.

Example 12: The display system of Example 11, where the first tilt angle and the second tilt angle are unequal.

Example 13: The display system of any of Examples 11 and 12, where the plurality of input optical elements each include a surface relief grating.

Example 14: The display system of any of Examples 11-13, where the projectors are disposed in a symmetric layout relative to the waveguide.

Example 15: The display system of any of Examples 11-13, where the projectors are disposed in an asymmetric layout relative to the waveguide.

Example 16: The display system of any of Examples 11-15, where the entrance pupil of at least one projector has a non-rotationally symmetric aperture.

Example 17: A method includes providing a waveguide having a surface and a display field of view defined by an angular range of display light out-coupled from the waveguide toward a user, the waveguide having a first input optical element and a second input optical element each disposed over the surface of the waveguide, emitting first display light from a first projector toward the first input optical element and coupling the first display light into the waveguide via the first input optical element, emitting second display light from a second projector toward the second input optical element and coupling the second display light into the waveguide via the second input optical element, and orienting the first projector at a first tilt angle relative to the waveguide surface and the second projector at a second tilt angle relative to the waveguide surface, where the first tilt angle is at least one-half of a field of view of the first projector and the second tilt angle is at least one-half of the field of view of the second projector such that light reflected at the first input optical element and at the second input optical element is not incident on a respective microdisplay panel of the first projector and the second projector.

Example 18: The method of Example 17, further including selecting the first tilt angle and the second tilt angle to be substantially symmetric about a plane normal to the waveguide surface.

Example 19: The method of any of Examples 17 and 18, further including out-coupling guided light from the waveguide toward a user via an output optical element configured to provide exit-pupil expansion in a lateral dimension corresponding to a combined field of view produced by the first display light and the second display light.

Example 20: The method of any of Examples 17-19, further including stitching, by a controller, images generated from the first projector and the second projector to produce a combined image that is substantially centered within a user's field of view.

Embodiments of the present disclosure may include or be implemented in conjunction with various types of Artificial reality (AR) systems. AR may be any superimposed functionality and/or sensory-detectable content presented by an artificial reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented reality environments (including marker-based augmented reality environments, markerless augmented reality environments, location-based augmented reality environments, and projection-based augmented reality environments), hybrid-reality environments, and/or any other type or form of mixed-or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

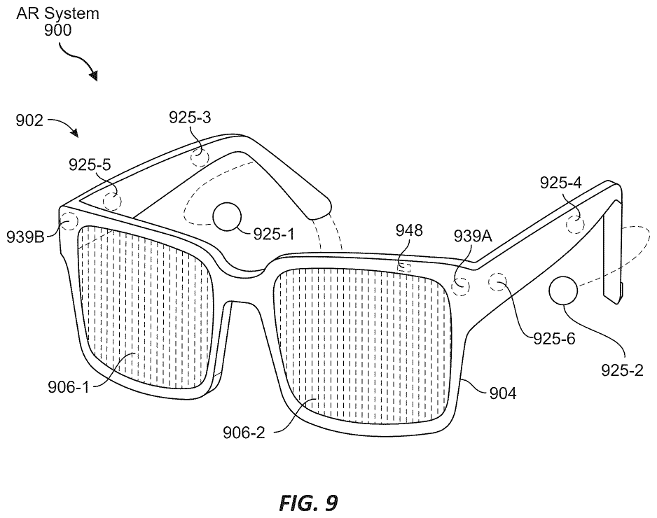

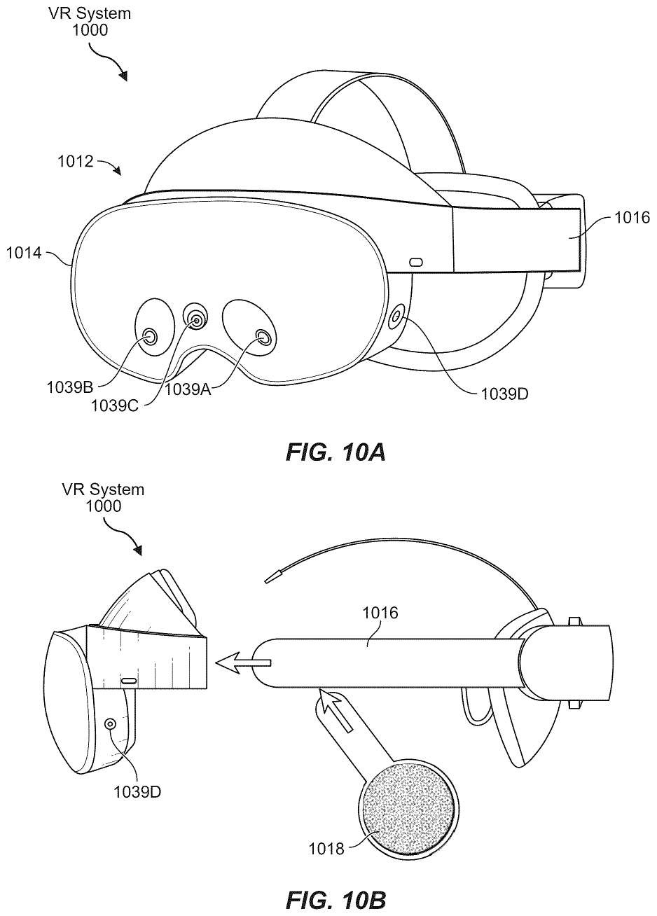

AR systems may be implemented in a variety of different form factors and configurations. Some AR systems may be designed to work without near-eye displays (NEDs). Other AR systems may include a NED that also provides visibility into the real world (such as, e.g., augmented reality system 900 in FIG. 9) or that visually immerses a user in an artificial reality (such as, e.g., virtual reality system 1000 in FIGS. 10A and 10B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

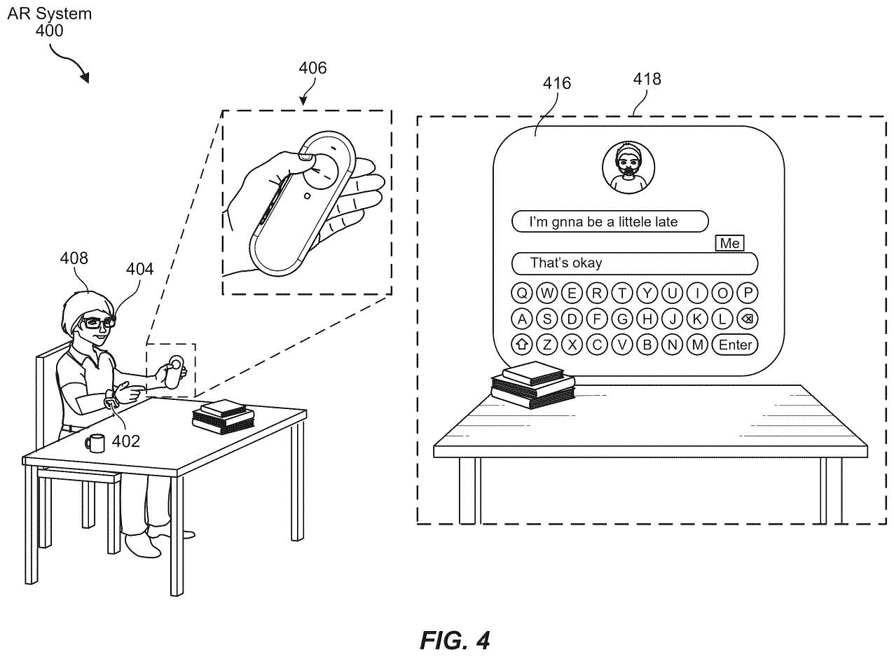

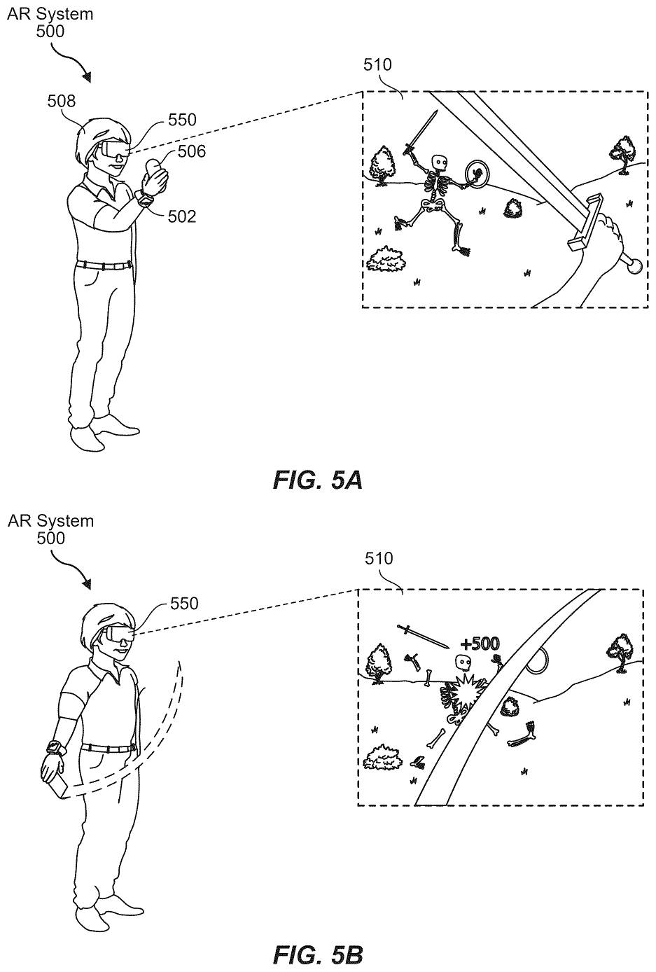

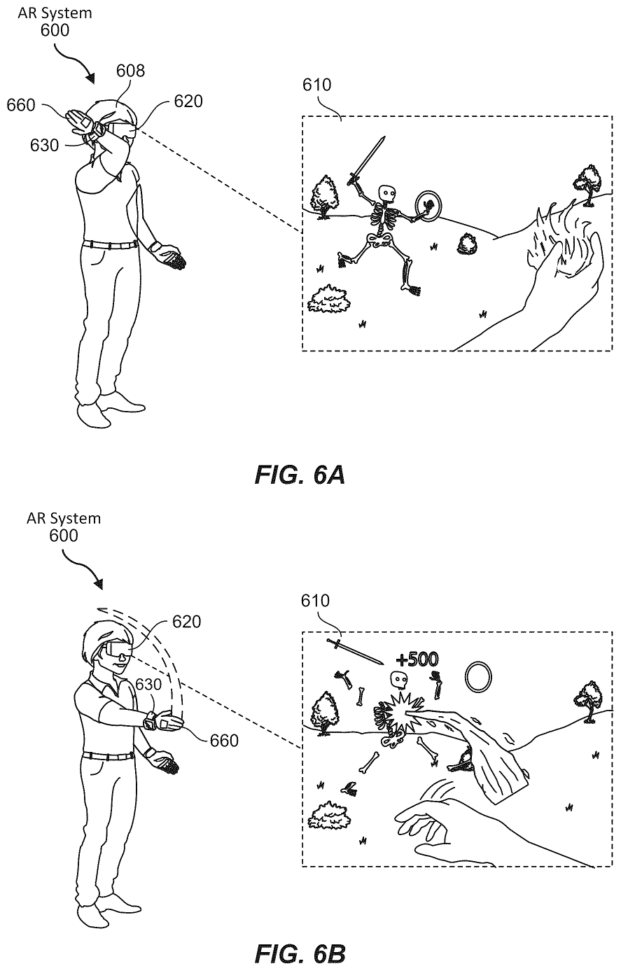

FIGS. 3-6B illustrate example artificial reality (AR) systems in accordance with some embodiments. FIG. 3 shows a first AR system 300 and first example user interactions using a wrist-wearable device 302, a head-wearable device (e.g., AR glasses 900), and/or a handheld intermediary processing device (HIPD) 306. FIG. 4 shows a second AR system 400 and second example user interactions using a wrist-wearable device 402, AR glasses 404, and/or an HIPD 406. FIGS. 5A and 5B show a third AR system 500 and third example user 508 interactions using a wrist-wearable device 502, a head-wearable device (e.g., VR headset 550), and/or an HIPD 506. FIGS. 6A and 6B show a fourth AR system 600 and fourth example user 608 interactions using a wrist-wearable device 630, VR headset 620, and/or a haptic device 660 (e.g., wearable gloves).

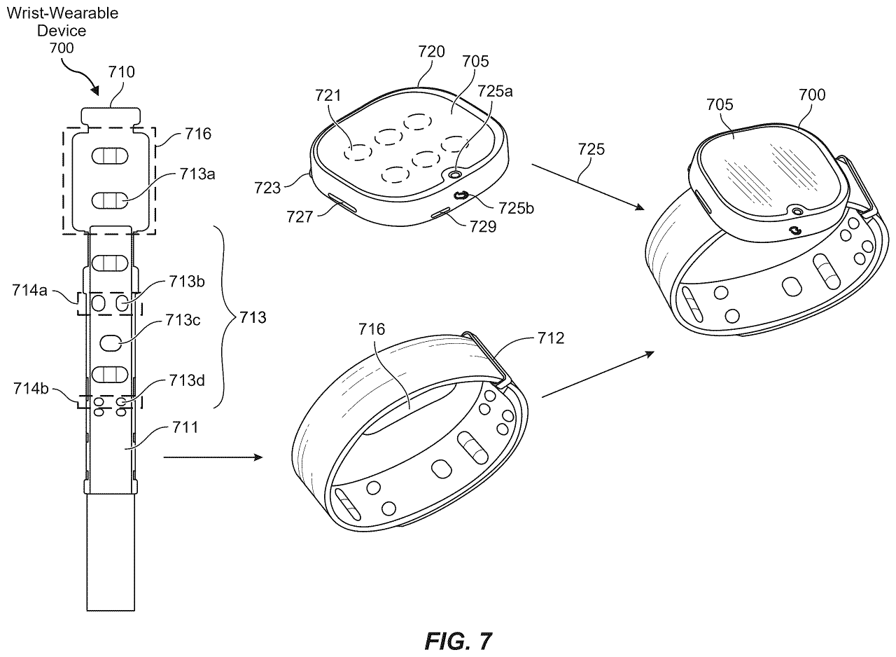

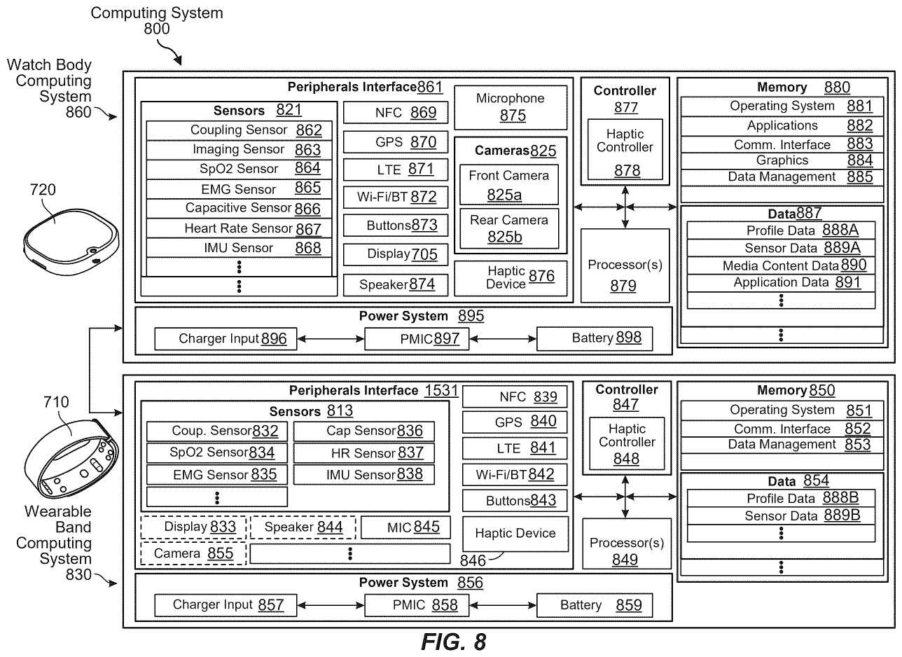

A wrist-wearable device 700, which can be used for wrist-wearable device 302, 402, 502, 630, and one or more of its components, are described below in reference to FIGS. 7 and 8; head-wearable devices 900 and 1000, which can respectively be used for AR glasses 304, 404 or VR headset 550, 620, and their one or more components are described below in reference to FIGS. 9-11.

Referring to FIG. 3, wrist-wearable device 302, AR glasses 304, and/or HIPD 306 can communicatively couple via a network 325 (e.g., cellular, near field, Wi-Fi, personal area network, wireless LAN, etc.). Additionally, wrist-wearable device 302, AR glasses 304, and/or HIPD 306 can also communicatively couple with one or more servers 330, computers 340 (e.g., laptops, computers, etc.), mobile devices 350 (e.g., smartphones, tablets, etc.), and/or other electronic devices via network 325 (e.g., cellular, near field, Wi-Fi, personal area network, wireless LAN, etc.).

In FIG. 3, a user 308 is shown wearing wrist-wearable device 302 and AR glasses 304 and having HIPD 306 on their desk. The wrist-wearable device 302, AR glasses 304, and HIPD 306 facilitate user interaction with an AR environment. In particular, as shown by first AR system 300, wrist-wearable device 302, AR glasses 304, and/or HIPD 306 cause presentation of one or more avatars 310, digital representations of contacts 312, and virtual objects 314. As discussed below, user 308 can interact with one or more avatars 310, digital representations of contacts 312, and virtual objects 314 via wrist-wearable device 302, AR glasses 304, and/or HIPD 306.

User 308 can use any of wrist-wearable device 302, AR glasses 304, and/or HIPD 306 to provide user inputs. For example, user 308 can perform one or more hand gestures that are detected by wrist-wearable device 302 (e.g., using one or more EMG sensors and/or IMUs, described below in reference to FIGS. 7 and 8) and/or AR glasses 304 (e.g., using one or more image sensor or camera, described below in reference to FIGS. 9-10) to provide a user input. Alternatively, or additionally, user 308 can provide a user input via one or more touch surfaces of wrist-wearable device 302, AR glasses 304, HIPD 306, and/or voice commands captured by a microphone of wrist-wearable device 302, AR glasses 304, and/or HIPD 306. In some embodiments, wrist-wearable device 302, AR glasses 304, and/or HIPD 306 include a digital assistant to help user 308 in providing a user input (e.g., completing a sequence of operations, suggesting different operations or commands, providing reminders, confirming a command, etc.). In some embodiments, user 308 can provide a user input via one or more facial gestures and/or facial expressions. For example, cameras of wrist-wearable device 302, AR glasses 304, and/or HIPD 306 can track eyes of user 308 for navigating a user interface.

Wrist-wearable device 302, AR glasses 304, and/or HIPD 306 can operate alone or in conjunction to allow user 308 to interact with the AR environment. In some embodiments, HIPD 306 is configured to operate as a central hub or control center for the wrist-wearable device 302, AR glasses 304, and/or another communicatively coupled device. For example, user 308 can provide an input to interact with the AR environment at any of wrist-wearable device 302, AR glasses 304, and/or HIPD 306, and HIPD 306 can identify one or more back-end and front-end tasks to cause the performance of the requested interaction and distribute instructions to cause the performance of the one or more back-end and front-end tasks at wrist-wearable device 302, AR glasses 304, and/or HIPD 306. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below in reference to FIG. 3, HIPD 306 can perform the back-end tasks and provide wrist-wearable device 302 and/or AR glasses 304 operational data corresponding to the performed back-end tasks such that wrist-wearable device 302 and/or AR glasses 304 can perform the front-end tasks. In this way, HIPD 306, which has more computational resources and greater thermal headroom than wrist-wearable device 302 and/or AR glasses 304, performs computationally intensive tasks and reduces the computer resource utilization and/or power usage of wrist-wearable device 302 and/or AR glasses 304.

In the example shown by first AR system 300, HIPD 306 identifies one or more back-end tasks and front-end tasks associated with a user request to initiate an AR video call with one or more other users (represented by avatar 310 and the digital representation of contact 312) and distributes instructions to cause the performance of the one or more back-end tasks and front-end tasks. In particular, HIPD 306 performs back-end tasks for processing and/or rendering image data (and other data) associated with the AR video call and provides operational data associated with the performed back-end tasks to AR glasses 304 such that the AR glasses 304 perform front-end tasks for presenting the AR video call (e.g., presenting avatar 310 and digital representation of contact 312).

In some embodiments, HIPD 306 can operate as a focal or anchor point for causing the presentation of information. This allows user 308 to be generally aware of where information is presented. For example, as shown in first AR system 300, avatar 310 and the digital representation of contact 312 are presented above HIPD 306. In particular, HIPD 306 and AR glasses 304 operate in conjunction to determine a location for presenting avatar 310 and the digital representation of contact 312. In some embodiments, information can be presented a predetermined distance from HIPD 306 (e.g., within 5 meters). For example, as shown in first AR system 300, virtual object 314 is presented on the desk some distance from HIPD 306. Similar to the above example, HIPD 306 and AR glasses 304 can operate in conjunction to determine a location for presenting virtual object 314. Alternatively, in some embodiments, presentation of information is not bound by HIPD 306. More specifically, avatar 310, digital representation of contact 312, and virtual object 314 do not have to be presented within a predetermined distance of HIPD 306.

User inputs provided at wrist-wearable device 302, AR glasses 304, and/or HIPD 306 are coordinated such that the user can use any device to initiate, continue, and/or complete an operation. For example, user 308 can provide a user input to AR glasses 304 to cause AR glasses 304 to present virtual object 314 and, while virtual object 314 is presented by AR glasses 304, user 308 can provide one or more hand gestures via wrist-wearable device 302 to interact and/or manipulate virtual object 314.

FIG. 4 shows a user 408 wearing a wrist-wearable device 402 and AR glasses 404, and holding an HIPD 406. In second AR system 400, the wrist-wearable device 402, AR glasses 404, and/or HIPD 406 are used to receive and/or provide one or more messages to a contact of user 408. In particular, wrist-wearable device 402, AR glasses 404, and/or HIPD 406 detect and coordinate one or more user inputs to initiate a messaging application and prepare a response to a received message via the messaging application.

In some embodiments, user 408 initiates, via a user input, an application on wrist-wearable device 402, AR glasses 404, and/or HIPD 406 that causes the application to initiate on at least one device. For example, in second AR system 400, user 408 performs a hand gesture associated with a command for initiating a messaging application (represented by messaging user interface 416), wrist-wearable device 402 detects the hand gesture and, based on a determination that user 408 is wearing AR glasses 404, causes AR glasses 404 to present a messaging user interface 416 of the messaging application. AR glasses 404 can present messaging user interface 416 to user 408 via its display (e.g., as shown by a field of view 418 of user 408). In some embodiments, the application is initiated and executed on the device (e.g., wrist-wearable device 402, AR glasses 404, and/or HIPD 406) that detects the user input to initiate the application, and the device provides another device operational data to cause the presentation of the messaging application. For example, wrist-wearable device 402 can detect the user input to initiate a messaging application, initiate and run the messaging application, and provide operational data to AR glasses 404 and/or HIPD 406 to cause presentation of the messaging application. Alternatively, the application can be initiated and executed at a device other than the device that detected the user input. For example, wrist-wearable device 402 can detect the hand gesture associated with initiating the messaging application and cause HIPD 406 to run the messaging application and coordinate the presentation of the messaging application.

Further, user 408 can provide a user input provided at wrist-wearable device 402, AR glasses 404, and/or HIPD 406 to continue and/or complete an operation initiated at another device. For example, after initiating the messaging application via wrist-wearable device 402 and while AR glasses 404 present messaging user interface 416, user 408 can provide an input at HIPD 406 to prepare a response (e.g., shown by the swipe gesture performed on HIPD 406). Gestures performed by user 408 on HIPD 406 can be provided and/or displayed on another device. For example, a swipe gestured performed on HIPD 406 is displayed on a virtual keyboard of messaging user interface 416 displayed by AR glasses 404.

In some embodiments, wrist-wearable device 402, AR glasses 404, HIPD 406, and/or any other communicatively coupled device can present one or more notifications to user 408. The notification can be an indication of a new message, an incoming call, an application update, a status update, etc. User 408 can select the notification via wrist-wearable device 402, AR glasses 404, and/or HIPD 406 and can cause presentation of an application or operation associated with the notification on at least one device. For example, user 408 can receive a notification that a message was received at wrist-wearable device 402, AR glasses 404, HIPD 406, and/or any other communicatively coupled device and can then provide a user input at wrist-wearable device 402, AR glasses 404, and/or HIPD 406 to review the notification, and the device detecting the user input can cause an application associated with the notification to be initiated and/or presented at wrist-wearable device 402, AR glasses 404, and/or HIPD 406.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 404 can present to user 408 game application data, and HIPD 406 can be used as a controller to provide inputs to the game. Similarly, user 408 can use wrist-wearable device 402 to initiate a camera of AR glasses 404, and user 308 can use wrist-wearable device 402, AR glasses 404, and/or HIPD 406 to manipulate the image capture (e.g., zoom in or out, apply filters, etc.) and capture image data.

Users may interact with the devices disclosed herein in a variety of ways. For example, as shown in FIGS. 5A and 5B, a user 508 may interact with an AR system 500 by donning a VR headset 550 while holding HIPD 506 and wearing wrist-wearable device 502. In this example, AR system 500 may enable a user to interact with a game 510 by swiping their arm. One or more of VR headset 550, HIPD 506, and wrist-wearable device 502 may detect this gesture and, in response, may display a sword strike in game 510. Similarly, in FIGS. 6A and 6B, a user 608 may interact with an AR system 600 by donning a VR headset 620 while wearing haptic device 660 and wrist-wearable device 630. In this example, AR system 600 may enable a user to interact with a game 610 by swiping their arm. One or more of VR headset 620, haptic device 660, and wrist-wearable device 630 may detect this gesture and, in response, may display a spell being cast in game 510.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (loT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiogra sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 902.15.4, Wi-Fi, ZigBee, 6LoWPAN, Thread, Z-Wave, Bluetooth Smart, ISA 100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 7 and 8 illustrate an example wrist-wearable device 700 and an example computer system 800, in accordance with some embodiments. Wrist-wearable device 700 is an instance of wearable device 302 described in FIG. 3 herein, such that the wearable device 302 should be understood to have the features of the wrist-wearable device 700 and vice versa. FIG. 8 illustrates components of the wrist-wearable device 700, which can be used individually or in combination, including combinations that include other electronic devices and/or electronic components.

FIG. 7 shows a wearable band 710 and a watch body 720 (or capsule) being coupled, as discussed below, to form wrist-wearable device 700. Wrist-wearable device 700 can perform various functions and/or operations associated with navigating through user interfaces and selectively opening applications as well as the functions and/or operations described above with reference to FIGS. 3-6B.

As will be described in more detail below, operations executed by wrist-wearable device 700 can include (i) presenting content to a user (e.g., displaying visual content via a display 705), (ii) detecting (e.g., sensing) user input (e.g., sensing a touch on peripheral button 723 and/or at a touch screen of the display 705, a hand gesture detected by sensors (e.g., biopotential sensors)), (iii) sensing biometric data (e.g., neuromuscular signals, heart rate, temperature, sleep, etc.) via one or more sensors 713, messaging (e.g., text, speech, video, etc.); image capture via one or more imaging devices or cameras 725, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 720, independently in wearable band 710, and/or via an electronic communication between watch body 720 and wearable band 710. In some embodiments, functions can be executed on wrist-wearable device 700 while an AR environment is being presented (e.g., via one of AR systems 300 to 600). The wearable devices described herein can also be used with other types of AR environments.

Wearable band 710 can be configured to be worn by a user such that an inner surface of a wearable structure 711 of wearable band 710 is in contact with the user's skin. In this example, when worn by a user, sensors 713 may contact the user's skin. In some examples, one or more of sensors 713 can sense biometric data such as a user's heart rate, a saturated oxygen level, temperature, sweat level, neuromuscular signals, or a combination thereof. One or more of sensors 713 can also sense data about a user's environment including a user's motion, altitude, location, orientation, gait, acceleration, position, or a combination thereof. In some embodiment, one or more of sensors 713 can be configured to track a position and/or motion of wearable band 710. One or more of sensors 713 can include any of the sensors defined above and/or discussed below with respect to FIG. 7.

One or more of sensors 713 can be distributed on an inside and/or an outside surface of wearable band 710. In some embodiments, one or more of sensors 713 are uniformly spaced along wearable band 710. Alternatively, in some embodiments, one or more of sensors 713 are positioned at distinct points along wearable band 710. As shown in FIG. 7, one or more of sensors 713 can be the same or distinct. For example, in some embodiments, one or more of sensors 713 can be shaped as a pill (e.g., sensor 713a), an oval, a circle a square, an oblong (e.g., sensor 713c) and/or any other shape that maintains contact with the user's skin (e.g., such that neuromuscular signal and/or other biometric data can be accurately measured at the user's skin). In some embodiments, one or more sensors of 713 are aligned to form pairs of sensors (e.g., for sensing neuromuscular signals based on differential sensing within each respective sensor). For example, sensor 713b may be aligned with an adjacent sensor to form sensor pair 714a and sensor 713d may be aligned with an adjacent sensor to form sensor pair 714b. In some embodiments, wearable band 710 does not have a sensor pair. Alternatively, in some embodiments, wearable band 710 has a predetermined number of sensor pairs (one pair of sensors, three pairs of sensors, four pairs of sensors, six pairs of sensors, sixteen pairs of sensors, etc.).

Wearable band 710 can include any suitable number of sensors 713. In some embodiments, the number and arrangement of sensors 713 depends on the particular application for which wearable band 710 is used. For instance, wearable band 710 can be configured as an armband, wristband, or chest-band that include a plurality of sensors 713 with different number of sensors 713, a variety of types of individual sensors with the plurality of sensors 713, and different arrangements for each use case, such as medical use cases as compared to gaming or general day-to-day use cases.

In accordance with some embodiments, wearable band 710 further includes an electrical ground electrode and a shielding electrode. The electrical ground and shielding electrodes, like the sensors 713, can be distributed on the inside surface of the wearable band 710 such that they contact a portion of the user's skin. For example, the electrical ground and shielding electrodes can be at an inside surface of a coupling mechanism 716 or an inside surface of a wearable structure 711. The electrical ground and shielding electrodes can be formed and/or use the same components as sensors 713. In some embodiments, wearable band 710 includes more than one electrical ground electrode and more than one shielding electrode.

Sensors 713 can be formed as part of wearable structure 711 of wearable band 710. In some embodiments, sensors 713 are flush or substantially flush with wearable structure 711 such that they do not extend beyond the surface of wearable structure 711. While flush with wearable structure 711, sensors 713 are still configured to contact the user's skin (e.g., via a skin-contacting surface). Alternatively, in some embodiments, sensors 713 extend beyond wearable structure 711 a predetermined distance (e.g., 0.1-2 mm) to make contact and depress into the user's skin. In some embodiment, sensors 713 are coupled to an actuator (not shown) configured to adjust an extension height (e.g., a distance from the surface of wearable structure 711) of sensors 713 such that sensors 713 make contact and depress into the user's skin. In some embodiments, the actuators adjust the extension height between 0.01 mm-1.2 mm. This may allow a the user to customize the positioning of sensors 713 to improve the overall comfort of the wearable band 710 when worn while still allowing sensors 713 to contact the user's skin. In some embodiments, sensors 713 are indistinguishable from wearable structure 711 when worn by the user.

Wearable structure 711 can be formed of an elastic material, elastomers, etc., configured to be stretched and fitted to be worn by the user. In some embodiments, wearable structure 711 is a textile or woven fabric. As described above, sensors 713 can be formed as part of a wearable structure 711. For example, sensors 713 can be molded into the wearable structure 711, be integrated into a woven fabric (e.g., sensors 713 can be sewn into the fabric and mimic the pliability of fabric and can and/or be constructed from a series woven strands of fabric).

Wearable structure 711 can include flexible electronic connectors that interconnect sensors 713, the electronic circuitry, and/or other electronic components (described below in reference to FIG. 8) that are enclosed in wearable band 710. In some embodiments, the flexible electronic connectors are configured to interconnect sensors 713, the electronic circuitry, and/or other electronic components of wearable band 710 with respective sensors and/or other electronic components of another electronic device (e.g., watch body 720). The flexible electronic connectors are configured to move with wearable structure 711 such that the user adjustment to wearable structure 711 (e.g., resizing, pulling, folding, etc.) does not stress or strain the electrical coupling of components of wearable band 710.

As described above, wearable band 710 is configured to be worn by a user. In particular, wearable band 710 can be shaped or otherwise manipulated to be worn by a user. For example, wearable band 710 can be shaped to have a substantially circular shape such that it can be configured to be worn on the user's lower arm or wrist. Alternatively, wearable band 710 can be shaped to be worn on another body part of the user, such as the user's upper arm (e.g., around a bicep), forearm, chest, legs, etc. Wearable band 710 can include a retaining mechanism 712 (e.g., a buckle, a hook and loop fastener, etc.) for securing wearable band 710 to the user's wrist or other body part. While wearable band 710 is worn by the user, sensors 713 sense data (referred to as sensor data) from the user's skin. In some examples, sensors 713 of wearable band 710 obtain (e.g., sense and record) neuromuscular signals.

The sensed data (e.g., sensed neuromuscular signals) can be used to detect and/or determine the user's intention to perform certain motor actions. In some examples, sensors 713 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 705 of wrist-wearable device 700 and/or can be transmitted to a device responsible for rendering an artificial reality environment (e.g., a head-mounted display) to perform an action in an associated artificial reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 713 can be used to provide a user with an enhanced interaction with a physical object (e.g., devices communicatively coupled with wearable band 710) and/or a virtual object in an artificial reality application generated by an artificial reality system (e.g., user interface objects presented on the display 705, or another computing device (e.g., a smartphone)).

In some embodiments, wearable band 710 includes one or more haptic devices 846 (e.g., a vibratory haptic actuator) that are configured to provide haptic feedback (e.g., a cutaneous and/or kinesthetic sensation, etc.) to the user's skin. Sensors 713 and/or haptic devices 846 (shown in FIG. 8) can be configured to operate in conjunction with multiple applications including, without limitation, health monitoring, social media, games, and artificial reality (e.g., the applications associated with artificial reality).

Wearable band 710 can also include coupling mechanism 716 for detachably coupling a capsule (e.g., a computing unit) or watch body 720 (via a coupling surface of the watch body 720) to wearable band 710. For example, a cradle or a shape of coupling mechanism 716 can correspond to shape of watch body 720 of wrist-wearable device 700. In particular, coupling mechanism 716 can be configured to receive a coupling surface proximate to the bottom side of watch body 720 (e.g., a side opposite to a front side of watch body 720 where display 705 is located), such that a user can push watch body 720 downward into coupling mechanism 716 to attach watch body 720 to coupling mechanism 716. In some embodiments, coupling mechanism 716 can be configured to receive a top side of the watch body 720 (e.g., a side proximate to the front side of watch body 720 where display 705 is located) that is pushed upward into the cradle, as opposed to being pushed downward into coupling mechanism 716. In some embodiments, coupling mechanism 716 is an integrated component of wearable band 710 such that wearable band 710 and coupling mechanism 716 are a single unitary structure. In some embodiments, coupling mechanism 716 is a type of frame or shell that allows watch body 720 coupling surface to be retained within or on wearable band 710 coupling mechanism 716 (e.g., a cradle, a tracker band, a support base, a clasp, etc.).

Coupling mechanism 716 can allow for watch body 720 to be detachably coupled to the wearable band 710 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 720 to wearable band 710 and to decouple the watch body 720 from the wearable band 710. For example, a user can twist, slide, turn, push, pull, or rotate watch body 720 relative to wearable band 710, or a combination thereof, to attach watch body 720 to wearable band 710 and to detach watch body 720 from wearable band 710. Alternatively, as discussed below, in some embodiments, the watch body 720 can be decoupled from the wearable band 710 by actuation of a release mechanism 729.

Wearable band 710 can be coupled with watch body 720 to increase the functionality of wearable band 710 (e.g., converting wearable band 710 into wrist-wearable device 700, adding an additional computing unit and/or battery to increase computational resources and/or a battery life of wearable band 710, adding additional sensors to improve sensed data, etc.). As described above, wearable band 710 and coupling mechanism 716 are configured to operate independently (e.g., execute functions independently) from watch body 720. For example, coupling mechanism 716 can include one or more sensors 713 that contact a user's skin when wearable band 710 is worn by the user, with or without watch body 720 and can provide sensor data for determining control commands.

A user can detach watch body 720 from wearable band 710 to reduce the encumbrance of wrist-wearable device 700 to the user. For embodiments in which watch body 720 is removable, watch body 720 can be referred to as a removable structure, such that in these embodiments wrist-wearable device 700 includes a wearable portion (e.g., wearable band 710) and a removable structure (e.g., watch body 720).

Turning to watch body 720, in some examples watch body 720 can have a substantially rectangular or circular shape. Watch body 720 is configured to be worn by the user on their wrist or on another body part. More specifically, watch body 720 is sized to be easily carried by the user, attached on a portion of the user's clothing, and/or coupled to wearable band 710 (forming the wrist-wearable device 700). As described above, watch body 720 can have a shape corresponding to coupling mechanism 716 of wearable band 710. In some embodiments, watch body 720 includes a single release mechanism 729 or multiple release mechanisms (e.g., two release mechanisms 729 positioned on opposing sides of watch body 720, such as spring-loaded buttons) for decoupling watch body 720 from wearable band 710. Release mechanism 729 can include, without limitation, a button, a knob, a plunger, a handle, a lever, a fastener, a clasp, a dial, a latch, or a combination thereof.

A user can actuate release mechanism 729 by pushing, turning, lifting, depressing, shifting, or performing other actions on release mechanism 729. Actuation of release mechanism 729 can release (e.g., decouple) watch body 720 from coupling mechanism 716 of wearable band 710, allowing the user to use watch body 720 independently from wearable band 710 and vice versa. For example, decoupling watch body 720 from wearable band 710 can allow a user to capture images using rear-facing camera 725b. Although release mechanism 729 is shown positioned at a corner of watch body 720, release mechanism 729 can be positioned anywhere on watch body 720 that is convenient for the user to actuate. In addition, in some embodiments, wearable band 710 can also include a respective release mechanism for decoupling watch body 720 from coupling mechanism 716. In some embodiments, release mechanism 729 is optional and watch body 720 can be decoupled from coupling mechanism 716 as described above (e.g., via twisting, rotating, etc.).

Watch body 720 can include one or more peripheral buttons 723 and 727 for performing various operations at watch body 720. For example, peripheral buttons 723 and 727 can be used to turn on or wake (e.g., transition from a sleep state to an active state) display 705, unlock watch body 720, increase or decrease a volume, increase or decrease a brightness, interact with one or more applications, interact with one or more user interfaces, etc. Additionally or alternatively, in some embodiments, display 705 operates as a touch screen and allows the user to provide one or more inputs for interacting with watch body 720.

In some embodiments, watch body 720 includes one or more sensors 721. Sensors 721 of watch body 720 can be the same or distinct from sensors 713 of wearable band 710. Sensors 721 of watch body 720 can be distributed on an inside and/or an outside surface of watch body 720. In some embodiments, sensors 721 are configured to contact a user's skin when watch body 720 is worn by the user. For example, sensors 721 can be placed on the bottom side of watch body 720 and coupling mechanism 716 can be a cradle with an opening that allows the bottom side of watch body 720 to directly contact the user's skin. Alternatively, in some embodiments, watch body 720 does not include sensors that are configured to contact the user's skin (e.g., including sensors internal and/or external to the watch body 720 that are configured to sense data of watch body 720 and the surrounding environment). In some embodiments, sensors 721 are configured to track a position and/or motion of watch body 720.

Watch body 720 and wearable band 710 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 720 and wearable band 710 can share data sensed by sensors 713 and 721, as well as application and device specific information (e.g., active and/or available applications, output devices (e.g., displays, speakers, etc.), input devices (e.g., touch screens, microphones, imaging sensors, etc.).

In some embodiments, watch body 720 can include, without limitation, a front-facing camera 725a and/or a rear-facing camera 725b, sensors 721 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 863), a touch sensor, a sweat sensor, etc.). In some embodiments, watch body 720 can include one or more haptic devices 876 (e.g., a vibratory haptic actuator) that is configured to provide haptic feedback (e.g., a cutaneous and/or kinesthetic sensation, etc.) to the user. Sensors 821 and/or haptic device 876 can also be configured to operate in conjunction with multiple applications including, without limitation, health monitoring applications, social media applications, game applications, and artificial reality applications (e.g., the applications associated with artificial reality).

As described above, watch body 720 and wearable band 710, when coupled, can form wrist-wearable device 700. When coupled, watch body 720 and wearable band 710 may operate as a single device to execute functions (operations, detections, communications, etc.) described herein. In some embodiments, each device may be provided with particular instructions for performing the one or more operations of wrist-wearable device 700. For example, in accordance with a determination that watch body 720 does not include neuromuscular signal sensors, wearable band 710 can include alternative instructions for performing associated instructions (e.g., providing sensed neuromuscular signal data to watch body 720 via a different electronic device). Operations of wrist-wearable device 700 can be performed by watch body 720 alone or in conjunction with wearable band 710 (e.g., via respective processors and/or hardware components) and vice versa. In some embodiments, operations of wrist-wearable device 700, watch body 720, and/or wearable band 710 can be performed in conjunction with one or more processors and/or hardware components.

As described below with reference to the block diagram of FIG. 8, wearable band 710 and/or watch body 720 can each include independent resources required to independently execute functions. For example, wearable band 710 and/or watch body 720 can each include a power source (e.g., a battery), a memory, data storage, a processor (e.g., a central processing unit (CPU)), communications, a light source, and/or input/output devices.

FIG. 8 shows block diagrams of a computing system 830 corresponding to wearable band 710 and a computing system 860 corresponding to watch body 720 according to some embodiments. Computing system 800 of wrist-wearable device 700 may include a combination of components of wearable band computing system 830 and watch body computing system 860, in accordance with some embodiments.

Watch body 720 and/or wearable band 710 can include one or more components shown in watch body computing system 860. In some embodiments, a single integrated circuit may include all or a substantial portion of the components of watch body computing system 860 included in a single integrated circuit. Alternatively, in some embodiments, components of the watch body computing system 860 may be included in a plurality of integrated circuits that are communicatively coupled. In some embodiments, watch body computing system 860 may be configured to couple (e.g., via a wired or wireless connection) with wearable band computing system 830, which may allow the computing systems to share components, distribute tasks, and/or perform other operations described herein (individually or as a single device).

Watch body computing system 860 can include one or more processors 879, a controller 877, a peripherals interface 861, a power system 895, and memory (e.g., a memory 880).

Power system 895 can include a charger input 896, a power-management integrated circuit (PMIC) 897, and a battery 898. In some embodiments, a watch body 720 and a wearable band 710 can have respective batteries (e.g., battery 898 and 859) and can share power with each other. Watch body 720 and wearable band 710 can receive a charge using a variety of techniques. In some embodiments, watch body 720 and wearable band 710 can use a wired charging assembly (e.g., power cords) to receive the charge. Alternatively, or in addition, watch body 720 and/or wearable band 710 can be configured for wireless charging. For example, a portable charging device can be designed to mate with a portion of watch body 720 and/or wearable band 710 and wirelessly deliver usable power to battery 898 of watch body 720 and/or battery 859 of wearable band 710. Watch body 720 and wearable band 710 can have independent power systems (e.g., power system 895 and 856, respectively) to enable each to operate independently. Watch body 720 and wearable band 710 can also share power (e.g., one can charge the other) via respective PMICs (e.g., PMICs 897 and 858) and charger inputs (e.g., 857 and 896) that can share power over power and ground conductors and/or over wireless charging antennas.

In some embodiments, peripherals interface 861 can include one or more sensors 821. Sensors 821 can include one or more coupling sensors 862 for detecting when watch body 720 is coupled with another electronic device (e.g., a wearable band 710). Sensors 821 can include one or more imaging sensors 863 (e.g., one or more of cameras 825, and/or separate imaging sensors 863 (e.g., thermal-imaging sensors)). In some embodiments, sensors 821 can include one or more SpO2 sensors 864. In some embodiments, sensors 821 can include one or more biopotential-signal sensors (e.g., EMG sensors 865, which may be disposed on an interior, user-facing portion of watch body 720 and/or wearable band 710). In some embodiments, sensors 821 may include one or more capacitive sensors 866. In some embodiments, sensors 821 may include one or more heart rate sensors 867. In some embodiments, sensors 821 may include one or more IMU sensors 868. In some embodiments, one or more IMU sensors 868 can be configured to detect movement of a user's hand or other location where watch body 720 is placed or held.

In some embodiments, one or more of sensors 821 may provide an example human-machine interface. For example, a set of neuromuscular sensors, such as EMG sensors 865, may be arranged circumferentially around wearable band 710 with an interior surface of EMG sensors 865 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 710 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 879. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 865 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 861 includes a near-field communication (NFC) component 869, a global-position system (GPS) component 870, a long-term evolution (LTE) component 871, and/or a Wi-Fi and/or Bluetooth communication component 872. In some embodiments, peripherals interface 861 includes one or more buttons 873 (e.g., peripheral buttons 723 and 727 in FIG. 7), which, when selected by a user, cause operation to be performed at watch body 720. In some embodiments, the peripherals interface 861 includes one or more indicators, such as a light emitting diode (LED), to provide a user with visual indicators (e.g., message received, low battery, active microphone and/or camera, etc.).

Watch body 720 can include at least one display 705 for displaying visual representations of information or data to a user, including user-interface elements and/or three-dimensional virtual objects. The display can also include a touch screen for inputting user inputs, such as touch gestures, swipe gestures, and the like. Watch body 720 can include at least one speaker 874 and at least one microphone 875 for providing audio signals to the user and receiving audio input from the user. The user can provide user inputs through microphone 875 and can also receive audio output from speaker 874 as part of a haptic event provided by haptic controller 878. Watch body 720 can include at least one camera 825, including a front camera 825a and a rear camera 825b. Cameras 825 can include ultra-wide-angle cameras, wide angle cameras, fish-eye cameras, spherical cameras, telephoto cameras, depth-sensing cameras, or other types of cameras.

Watch body computing system 860 can include one or more haptic controllers 878 and associated componentry (e.g., haptic devices 876) for providing haptic events at watch body 720 (e.g., a vibrating sensation or audio output in response to an event at the watch body 720). Haptic controllers 878 can communicate with one or more haptic devices 876, such as electroacoustic devices, including a speaker of the one or more speakers 874 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 878 can provide haptic events to that are capable of being sensed by a user of watch body 720. In some embodiments, one or more haptic controllers 878 can receive input signals from an application of applications 882.

In some embodiments, wearable band computing system 830 and/or watch body computing system 860 can include memory 880, which can be controlled by one or more memory controllers of controllers 877. In some embodiments, software components stored in memory 880 include one or more applications 882 configured to perform operations at the watch body 720. In some embodiments, one or more applications 882 may include games, word processors, messaging applications, calling applications, web browsers, social media applications, media streaming applications, financial applications, calendars, clocks, etc. In some embodiments, software components stored in memory 880 include one or more communication interface modules 883 as defined above. In some embodiments, software components stored in memory 880 include one or more graphics modules 884 for rendering, encoding, and/or decoding audio and/or visual data and one or more data management modules 885 for collecting, organizing, and/or providing access to data 887 stored in memory 880. In some embodiments, one or more of applications 882 and/or one or more modules can work in conjunction with one another to perform various tasks at the watch body 720.

In some embodiments, software components stored in memory 880 can include one or more operating systems 881 (e.g., a Linux-based operating system, an Android operating system, etc.). Memory 880 can also include data 887. Data 887 can include profile data 888A, sensor data 889A, media content data 890, and application data 891.

It should be appreciated that watch body computing system 860 is an example of a computing system within watch body 720, and that watch body 720 can have more or fewer components than shown in watch body computing system 860, can combine two or more components, and/or can have a different configuration and/or arrangement of the components. The various components shown in watch body computing system 860 are implemented in hardware, software, firmware, or a combination thereof, including one or more signal processing and/or application-specific integrated circuits.

Turning to the wearable band computing system 830, one or more components that can be included in wearable band 710 are shown. Wearable band computing system 830 can include more or fewer components than shown in watch body computing system 860, can combine two or more components, and/or can have a different configuration and/or arrangement of some or all of the components. In some embodiments, all, or a substantial portion of the components of wearable band computing system 830 are included in a single integrated circuit. Alternatively, in some embodiments, components of wearable band computing system 830 are included in a plurality of integrated circuits that are communicatively coupled. As described above, in some embodiments, wearable band computing system 830 is configured to couple (e.g., via a wired or wireless connection) with watch body computing system 860, which allows the computing systems to share components, distribute tasks, and/or perform other operations described herein (individually or as a single device).

Wearable band computing system 830, similar to watch body computing system 860, can include one or more processors 849, one or more controllers 847 (including one or more haptics controllers 848), a peripherals interface 831 that can includes one or more sensors 813 and other peripheral devices, a power source (e.g., a power system 856), and memory (e.g., a memory 850) that includes an operating system (e.g., an operating system 851), data (e.g., data 854 including profile data 888B, sensor data 889B, etc.), and one or more modules (e.g., a communications interface module 852, a data management module 853, etc.).

One or more of sensors 813 can be analogous to sensors 821 of watch body computing system 860. For example, sensors 813 can include one or more coupling sensors 832, one or more SpO2 sensors 834, one or more EMG sensors 835, one or more capacitive sensors 836, one or more heart rate sensors 837, and one or more IMU sensors 838.

Peripherals interface 831 can also include other components analogous to those included in peripherals interface 861 of watch body computing system 860, including an NFC component 839, a GPS component 840, an LTE component 841, a Wi-Fi and/or Bluetooth communication component 842, and/or one or more haptic devices 846 as described above in reference to peripherals interface 861. In some embodiments, peripherals interface 831 includes one or more buttons 843, a display 833, a speaker 844, a microphone 845, and a camera 855. In some embodiments, peripherals interface 831 includes one or more indicators, such as an LED.

It should be appreciated that wearable band computing system 830 is an example of a computing system within wearable band 710, and that wearable band 710 can have more or fewer components than shown in wearable band computing system 830, combine two or more components, and/or have a different configuration and/or arrangement of the components. The various components shown in wearable band computing system 830 can be implemented in one or more of a combination of hardware, software, or firmware, including one or more signal processing and/or application-specific integrated circuits.

Wrist-wearable device 700 with respect to FIG. 7 is an example of wearable band 710 and watch body 720 coupled together, so wrist-wearable device 700 will be understood to include the components shown and described for wearable band computing system 830 and watch body computing system 860. In some embodiments, wrist-wearable device 700 has a split architecture (e.g., a split mechanical architecture, a split electrical architecture, etc.) between watch body 720 and wearable band 710. In other words, all of the components shown in wearable band computing system 830 and watch body computing system 860 can be housed or otherwise disposed in a combined wrist-wearable device 700 or within individual components of watch body 720, wearable band 710, and/or portions thereof (e.g., a coupling mechanism 716 of wearable band 710).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 700 can be used in conjunction with a head-wearable device (e.g., AR glasses 900 and VR system 1010) and/or an HIPD described herein, and wrist-wearable device 700 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 900 and VR headset 1010.

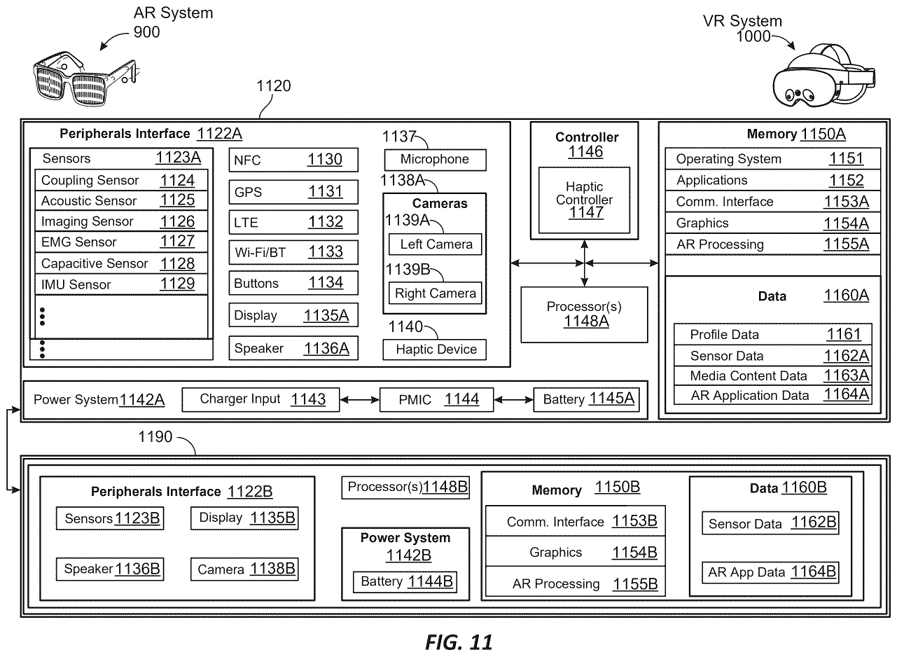

FIGS. 9 to 11 show example artificial reality systems, which can be used as or in connection with wrist-wearable device 700. In some embodiments, AR system 900 includes an eyewear device 902, as shown in FIG. 9. In some embodiments, VR system 1010 includes a head-mounted display (HMD) 1012, as shown in FIGS. 10A and 10B. In some embodiments, AR system 900 and VR system 1010 can include one or more analogous components (e.g., components for presenting interactive artificial reality environments, such as processors, memory, and/or presentation devices, including one or more displays and/or one or more waveguides), some of which are described in more detail with respect to FIG. 11. As described herein, a head-wearable device can include components of eyewear device 902 and/or head-mounted display 1012. Some embodiments of head-wearable devices do not include any displays, including any of the displays described with respect to AR system 900 and/or VR system 1010. While the example artificial reality systems are respectively described herein as AR system 900 and VR system 1010, either or both of the example AR systems described herein can be configured to present fully-immersive virtual reality scenes presented in substantially all of a user's field of view or subtler augmented reality scenes that are presented within a portion, less than all, of the user's field of view.

FIG. 9 show an example visual depiction of AR system 900, including an eyewear device 902 (which may also be described herein as augmented reality glasses, and/or smart glasses). AR system 900 can include additional electronic components that are not shown in FIG. 9, such as a wearable accessory device and/or an intermediary processing device, in electronic communication or otherwise configured to be used in conjunction with the eyewear device 902. In some embodiments, the wearable accessory device and/or the intermediary processing device may be configured to couple with eyewear device 902 via a coupling mechanism in electronic communication with a coupling sensor 1124 (FIG. 11), where coupling sensor 1124 can detect when an electronic device becomes physically or electronically coupled with eyewear device 902. In some embodiments, eyewear device 902 can be configured to couple to a housing 1190 (FIG. 11), which may include one or more additional coupling mechanisms configured to couple with additional accessory devices. The components shown in FIG. 9 can be implemented in hardware, software, firmware, or a combination thereof, including one or more signal-processing components and/or application-specific integrated circuits (ASICs).

Eyewear device 902 includes mechanical glasses components, including a frame 904 configured to hold one or more lenses (e.g., one or both lenses 906-1 and 906-2). One of ordinary skill in the art will appreciate that eyewear device 902 can include additional mechanical components, such as hinges configured to allow portions of frame 904 of eyewear device 902 to be folded and unfolded, a bridge configured to span the gap between lenses 906-1 and 906-2 and rest on the user's nose, nose pads configured to rest on the bridge of the nose and provide support for eyewear device 902, earpieces configured to rest on the user's ears and provide additional support for eyewear device 902, temple arms configured to extend from the hinges to the earpieces of eyewear device 902, and the like. One of ordinary skill in the art will further appreciate that some examples of AR system 900 can include none of the mechanical components described herein. For example, smart contact lenses configured to present artificial reality to users may not include any components of eyewear device 902.

Eyewear device 902 includes electronic components, many of which will be described in more detail below with respect to FIG. 10. Some example electronic components are illustrated in FIG. 9, including acoustic sensors 925-1, 925-2, 925-3, 925-4, 925-5, and 925-6, which can be distributed along a substantial portion of the frame 904 of eyewear device 902. Eyewear device 902 also includes a left camera 939A and a right camera 939B, which are located on different sides of the frame 904. Eyewear device 902 also includes a processor 948 (or any other suitable type or form of integrated circuit) that is embedded into a portion of the frame 904.

FIGS. 10A and 10B show a VR system 1010 that includes a head-mounted display (HMD) 1012 (e.g., also referred to herein as an artificial reality headset, a head-wearable device, a VR headset, etc.), in accordance with some embodiments. As noted, some artificial reality systems (e.g., AR system 900) may, instead of blending an artificial reality with actual reality, substantially replace one or more of a user's visual and/or other sensory perceptions of the real world with a virtual experience (e.g., AR systems 500 and 600).

HMD 1012 includes a front body 1014 and a frame 1016 (e.g., a strap or band) shaped to fit around a user's head. In some embodiments, front body 1014 and/or frame 1016 include one or more electronic elements for facilitating presentation of and/or interactions with an AR and/or VR system (e.g., displays, IMUs, tracking emitter or detectors). In some embodiments, HMD 1012 includes output audio transducers (e.g., an audio transducer 1018), as shown in FIG. 10B. In some embodiments, one or more components, such as the output audio transducer(s) 1018 and frame 1016, can be configured to attach and detach (e.g., are detachably attachable) to HMD 1012 (e.g., a portion or all of frame 1016, and/or audio transducer 1018), as shown in FIG. 10B. In some embodiments, coupling a detachable component to HMD 1012 causes the detachable component to come into electronic communication with HMD 1012.

FIGS. 10A and 10B also show that VR system 1010 includes one or more cameras, such as left camera 1039A and right camera 1039B, which can be analogous to left and right cameras 939A and 939B on frame 904 of eyewear device 902. In some embodiments, VR system 1010 includes one or more additional cameras (e.g., cameras 1039C and 1039D), which can be configured to augment image data obtained by left and right cameras 1039A and 1039B by providing more information. For example, camera 1039C can be used to supply color information that is not discerned by cameras 1039A and 1039B. In some embodiments, one or more of cameras 1039A to 1039D can include an optional IR cut filter configured to remove IR light from being received at the respective camera sensors.

FIG. 11 illustrates a computing system 1120 and an optional housing 1190, each of which show components that can be included in AR system 900 and/or VR system 1010. In some embodiments, more or fewer components can be included in optional housing 1190 depending on practical restraints of the respective AR system being described.

In some embodiments, computing system 1120 can include one or more peripherals interfaces 1122A and/or optional housing 1190 can include one or more peripherals interfaces 1122B. Each of computing system 1120 and optional housing 1190 can also include one or more power systems 1142A and 1142B, one or more controllers 1146 (including one or more haptic controllers 1147), one or more processors 1148A and 1148B (as defined above, including any of the examples provided), and memory 1150A and 1150B, which can all be in electronic communication with each other. For example, the one or more processors 1148A and 1148B can be configured to execute instructions stored in memory 1150A and 1150B, which can cause a controller of one or more of controllers 1146 to cause operations to be performed at one or more peripheral devices connected to peripherals interface 1122A and/or 1122B. In some embodiments, each operation described can be powered by electrical power provided by power system 1142A and/or 1142B.

In some embodiments, peripherals interface 1122A can include one or more devices configured to be part of computing system 1120, some of which have been defined above and/or described with respect to the wrist-wearable devices shown in FIGS. 7 and 8. For example, peripherals interface 1122A can include one or more sensors 1123A. Some example sensors 1123A include one or more coupling sensors 1124, one or more acoustic sensors 1125, one or more imaging sensors 1126, one or more EMG sensors 1127, one or more capacitive sensors 1128, one or more IMU sensors 1129, and/or any other types of sensors explained above or described with respect to any other embodiments discussed herein.

In some embodiments, peripherals interfaces 1122A and 1122B can include one or more additional peripheral devices, including one or more NFC devices 1130, one or more GPS devices 1131, one or more LTE devices 1132, one or more Wi-Fi and/or Bluetooth devices 1133, one or more buttons 1134 (e.g., including buttons that are slidable or otherwise adjustable), one or more displays 1135A and 1135B, one or more speakers 1136A and 1136B, one or more microphones 1137, one or more cameras 1138A and 1138B (e.g., including the left camera 1139A and/or a right camera 1139B), one or more haptic devices 1140, and/or any other types of peripheral devices defined above or described with respect to any other embodiments discussed herein.

AR systems can include a variety of types of visual feedback mechanisms (e.g., presentation devices). For example, display devices in AR system 900 and/or VR system 1010 can include one or more liquid-crystal displays (LCDs), light emitting diode (LED) displays, organic LED (OLED) displays, and/or any other suitable types of display screens. Artificial reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 1135A and 1135B can be coupled to each of the lenses 906-1 and 906-2 of AR system 900. Displays 1135A and 1135B may be coupled to each of lenses 906-1 and 906-2, which can act together or independently to present an image or series of images to a user. In some embodiments, AR system 900 includes a single display 1135A or 1135B (e.g., a near-eye display) or more than two displays 1135A and 1135B. In some embodiments, a first set of one or more displays 1135A and 1135B can be used to present an augmented reality environment, and a second set of one or more display devices 1135A and 1135B can be used to present a virtual reality environment. In some embodiments, one or more waveguides are used in conjunction with presenting artificial reality content to the user of AR system 900 (e.g., as a means of delivering light from one or more displays 1135A and 1135B to the user's eyes). In some embodiments, one or more waveguides are fully or partially integrated into the eyewear device 902. Additionally, or alternatively to display screens, some artificial reality systems include one or more projection systems. For example, display devices in AR system 900 and/or VR system 1010 can include micro-LED projectors that project light (e.g., using a waveguide) into display devices, such as clear combiner lenses that allow ambient light to pass through. The display devices can refract the projected light toward a user's pupil and can enable a user to simultaneously view both artificial reality content and the real world. Artificial reality systems can also be configured with any other suitable type or form of image projection system. In some embodiments, one or more waveguides are provided additionally or alternatively to the one or more display(s) 1135A and 1135B.

Computing system 1120 and/or optional housing 1190 of AR system 900 or VR system 1010 can include some or all of the components of a power system 1142A and 1142B. Power systems 1142A and 1142B can include one or more charger inputs 1143, one or more PMICs 1144, and/or one or more batteries 1145A and 1144B.

Memory 1150A and 1150B may include instructions and data, some or all of which may be stored as non-transitory computer-readable storage media within the memories 1150A and 1150B. For example, memory 1150A and 1150B can include one or more operating systems 1151, one or more applications 1152, one or more communication interface applications 1153A and 1153B, one or more graphics applications 1154A and 1154B, one or more AR processing applications 1155A and 1155B, and/or any other types of data defined above or described with respect to any other embodiments discussed herein.

Memory 1150A and 1150B also include data 1160A and 1160B, which can be used in conjunction with one or more of the applications discussed above. Data 1160A and 1160B can include profile data 1161, sensor data 1162A and 1162B, media content data 1163A, AR application data 1164A and 1164B, and/or any other types of data defined above or described with respect to any other embodiments discussed herein.

In some embodiments, controller 1146 of eyewear device 902 may process information generated by sensors 1123A and/or 1123B on eyewear device 902 and/or another electronic device within AR system 900. For example, controller 1146 can process information from acoustic sensors 925-1 and 925-2. For each detected sound, controller 1146 can perform a direction of arrival (DOA) estimation to estimate a direction from which the detected sound arrived at eyewear device 902 of R system 900. As one or more of acoustic sensors 1125 (e.g., the acoustic sensors 925-1, 925-2) detects sounds, controller 1146 can populate an audio data set with the information (e.g., represented in FIG. 10 as sensor data 1162A and 1162B).

In some embodiments, a physical electronic connector can convey information between eyewear device 902 and another electronic device and/or between one or more processors 948, 1148A, 1148B of AR system 900 or VR system 1010 and controller 1146. The information can be in the form of optical data, electrical data, wireless data, or any other transmittable data form. Moving the processing of information generated by eyewear device 902 to an intermediary processing device can reduce weight and heat in the eyewear device, making it more comfortable and safer for a user. In some embodiments, an optional wearable accessory device (e.g., an electronic neckband) is coupled to eyewear device 902 via one or more connectors. The connectors can be wired or wireless connectors and can include electrical and/or non-electrical (e.g., structural) components. In some embodiments, eyewear device 902 and the wearable accessory device can operate independently without any wired or wireless connection between them.

In some situations, pairing external devices, such as an intermediary processing device (e.g., HIPD 306, 406, 506) with eyewear device 902 (e.g., as part of AR system 900) enables eyewear device 902 to achieve a similar form factor of a pair of glasses while still providing sufficient battery and computation power for expanded capabilities. Some, or all, of the battery power, computational resources, and/or additional features of AR system 900 can be provided by a paired device or shared between a paired device and eyewear device 902, thus reducing the weight, heat profile, and form factor of eyewear device 902 overall while allowing eyewear device 902 to retain its desired functionality. For example, the wearable accessory device can allow components that would otherwise be included on eyewear device 902 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 902 standing alone. Because weight carried in the wearable accessory device can be less invasive to a user than weight carried in the eyewear device 902, a user may tolerate wearing a lighter eyewear device and carrying or wearing the paired device for greater lengths of time than the user would tolerate wearing a heavier eyewear device standing alone, thereby enabling an artificial reality environment to be incorporated more fully into a user's day-to-day activities.

AR systems can include various types of computer vision components and subsystems. For example, AR system 900 and/or VR system 1010 can include one or more optical sensors such as two-dimensional (2D) or three-dimensional (3D) cameras, time-of-flight depth sensors, structured light transmitters and detectors, single-beam or sweeping laser rangefinders, 3D LIDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 10A and 10B show VR system 1010 having cameras 1039A to 1039D, which can be used to provide depth information for creating a voxel field and a two-dimensional mesh to provide object information to the user to avoid collisions.

In some embodiments, AR system 900 and/or VR system 1010 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial reality devices, within other artificial reality devices, and/or in conjunction with other artificial reality devices.

In some embodiments of an artificial reality system, such as AR system 900 and/or VR system 1010, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.” It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a lens that comprises or includes polycarbonate include embodiments where a lens consists essentially of polycarbonate and embodiments where a lens consists of polycarbonate.

What is claimed is:

1. A display system comprising:
a waveguide having a surface and a display field of view (FOV) defined by an angular range of display light out-coupled from the waveguide toward a user;
first and second input optical elements disposed over the surface of the waveguide;
a first projector configured to emit first display light to the first input optical element, wherein the first input optical element is configured to couple the first display light into the waveguide; and
a second projector configured to emit second display light to the second input optical element, wherein the second input optical element is configured to couple the second display light into the waveguide, wherein:
the first projector is oriented at a first tilt angle relative to the waveguide surface and the second projector is oriented at a second tilt angle relative to the waveguide surface,
the first tilt angle is at least one-half of a field of view of the first projector, and
the second tilt angle is at least one-half of a field of view of the second projector.

2. The display system of claim 1, wherein the waveguide comprises a transparent substrate and further comprises an output optical element configured to out-couple guided light toward a user with exit pupil expansion in a lateral dimension corresponding to a combined field of view produced by the first display light and the second display light.

3. The display system of claim 1, wherein the first tilt angle is unequal to the second tilt angle.

4. The display system of claim 1, wherein the first and second input optical elements each comprise a surface-relief diffraction grating.

5. The display system of claim 1, wherein the first and second input optical elements comprise vertically oriented grating couplers configured to convert out-of-plane display light to tilted guided light within the waveguide.

6. The display system of claim 1, wherein the first and second projectors each comprise a microdisplay panel and collimation optics defining an entrance pupil having a non-rotationally symmetric aperture.

7. The display system of claim 1, wherein the first projector and the second projector are arranged in an asymmetric layout.

8. The display system of claim 1, wherein the first tilt angle and the second tilt angle are opposite in sign.

9. The display system of claim 1, wherein the first tilt angle differs from the second tilt angle by at least five degrees.

10. The display system of claim 1, wherein the first and second tilt angles are symmetric about a plane normal to the waveguide surface.

11. A display system comprising:
a waveguide having a surface and a display field of view defined by an angular range of display light out-coupled from the waveguide toward a user;
a plurality of input optical elements disposed over the surface of the waveguide;
for each of a plurality of colors, at least two projectors respectively configured to emit display light to corresponding input optical elements, wherein the corresponding input optical elements are configured to couple the display light into the waveguide,
wherein each projector comprises a microdisplay panel and collimation optics defining an entrance pupil, and each projector is oriented at a respective tilt angle relative to the waveguide surface such that light reflected at the corresponding input optical element is not incident on the microdisplay panel; and
a controller configured to stitch images from the at least two projectors for each color to produce a combined image having a field of view that is substantially centered within the user's field of view.

12. The display system of claim 11, wherein the first tilt angle is unequal to the second tilt angle.

13. The display system of claim 11, wherein the plurality of input optical elements each comprise a surface relief grating.

14. The display system of claim 11, wherein the projectors are disposed in a symmetric layout relative to the waveguide.

15. The display system of claim 11, wherein the projectors are disposed in an asymmetric layout relative to the waveguide.

16. The display system of claim 11, wherein the entrance pupil of at least one projector has a non-rotationally symmetric aperture.

17. A method comprising:
providing a waveguide having a surface and a display field of view defined by an angular range of display light out-coupled from the waveguide toward a user, the waveguide comprising a first input optical element and a second input optical element each disposed over the surface of the waveguide;
emitting first display light from a first projector toward the first input optical element and coupling the first display light into the waveguide via the first input optical element;
emitting second display light from a second projector toward the second input optical element and coupling the second display light into the waveguide via the second input optical element; and
orienting the first projector at a first tilt angle relative to the waveguide surface and the second projector at a second tilt angle relative to the waveguide surface, wherein the first tilt angle is at least one-half of a field of view of the first projector and the second tilt angle is at least one-half of the field of view of the second projector such that light reflected at the first input optical element and at the second input optical element is not incident on a respective microdisplay panel of the first projector and the second projector.

18. The method of claim 17, further comprising selecting the first tilt angle and the second tilt angle to be substantially symmetric about a plane normal to the waveguide surface.

19. The method of claim 17, further comprising out-coupling guided light from the waveguide toward a user via an output optical element configured to provide exit-pupil expansion in a lateral dimension corresponding to a combined field of view produced by the first display light and the second display light.

20. The method of claim 17, further comprising stitching, by a controller, images generated from the first projector and the second projector to produce a combined image that is substantially centered within a user's field of view.
